(19) United States
(12) Patent Application Publication
(10) Pub. No.: US 2004/0078220 A1
(43) Pub. Date: Apr. 22, 2004

(54) System and method for collection, distribution, and use of information in connection with health care delivery

(76) Inventor: Becky L. Jackson, Chevy Chase, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/311,198

(22) PCT Filed: Jun. 14, 2001
(86) PCT No.: PCT/US01/14856

(51) Int. Cl. G06F 17/60

(52) U.S. Cl. 705/2

(57) ABSTRACT

A health care system includes a hosted environment (4, 6) that provides health care treatment, diagnosis, and/or management. Health care providers (2a-2g) are linked to one another and to a central network, which is linked to patient (3a, 3b) via the hosted environment. The patient (3a, 3b) interfaces with the hosted environment (4, 6), which provides the global access to the health care provider (2a-2g). The patient may also have medical devices (7) that facilitate collection of vital sign data (e.g., digital thermometer) and administration of treatment (e.g., medicine dispensary). The health care provider (2a-2g) can license the hosted environment (4, 6) to generate the treatment tree and perform the treatment. Thus, treatment is performed remotely based on globally standardized protocols. Additionally, a virtual clinical research organization (CRO) is provided, such that treating physicians and patients can participate in clinical trials and have access to new medical treatments.

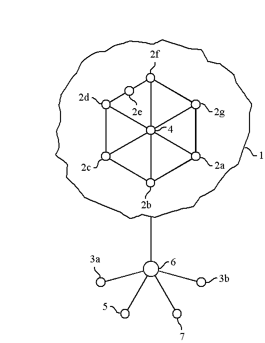

This application claims the benefit of U.S. Provisional Application No. 60/211,380, filed Jun. 14, 2000, under 35 U.S.C. §119(e).

### BACKGROUND OF THE INVENTION

1. Field of the Invention

The present invention relates to a system and method for providing health care treatment to a patient from a health care provider, and more specifically, remotely providing health care treatment via an application service provider (ASP) that is secure, remotely accessible and globally standardized.

2. Background of the Prior Art

In the related art, health care treatment systems require physical or non-networked interaction between a patient and health care provider. For example, but not by way of limitation, a patient must make an appointment to visit a health care provider (e.g., physician) in order to obtain treatment. In the prior art, any coordination between health care providers is conducted on an ad hoc basis, and there is no standardization or coordination. Further, the patient's knowledge about his or her own condition is not included, and there is no structure in the prior art system for collaborative effort or informed patient direction or participation in his or her medical care and treatment.

Further, each health care provider is disaggregated from other health care providers, such that if a patient requests diagnosis and/or treatment by a health care provider who did not participate in prior treatment, there is no prior art system to provide this treating physician with the prior treating physician's expert knowledge about the prior treatment, because health care providers are not interconnected. The prior art system does not provide any reimbursement or other incentive for health care providers to interconnect their services with one another so as to provide a community of service to the patient. The only incentive is good will to foster referras, which does not promote treatment by other physicians on a large-scale, standardized level. It is also a disadvantage of the prior art that there is also no central repository for treating health care providers' knowledge, experience and expertise related to a patient that can be accessed either by subsequent treating providers or the patient.

FIG. 1 illustrates the prior art system of heath care treatment. In a pool 1 of health care providers 2a . . . 2g, none of the health care providers are interconnected to one another or to a common central station.

The prior art system has various problems and disadvantages, including, but not limited to, non-standardization between health care providers. For example, but not by way of limitation, a first health care provider 2a may be located in a first country (e.g., United States), whereas a second health provider 2b may be located in a second country (e.g., United Kingdom), and due to the currency barrier, the first and second health care providers 2a, 2b cannot interface with one another to treat patients who may be working and/or travelling abroad. Also, where a patient has traveled from the first health provider 2a (e.g., in the United States) to a third health care provider 2c in a third country (e.g., Nepal), the health care providers 2a, 2c cannot interface due to a lack of standardization in health care management, diagnosis and/or treatment.

Further, a fourth health care provider 2d located in a first state (e.g., Michigan) and a fifth health care provider 2e located in a province of a nearby country (e.g., Ontario) may not be able to interface due to a difference in currencies and currency exchange rates. Additionally, a sixth health care provider 2f and a seventh health care provider 2g may not be able to communicate with another due to individual providers having different languages, protocols, or licensing credentials, even if they are in the same jurisdiction. Thus, a need exists for standardization that has not been met due to various inherent barriers of the prior art.

An additional barrier to standardization is licensure requirements. Currently, a health care provider in the United States is licensed on a state-by-state basis. Only licensed health care providers may provide medical care and treatment in accordance with state licensure. There is no structure by which patients can be treated on a hosted remote ASP basis. Additionally, it is not possible for the national expert licensed in state A to treat patients out of state unless the patient travels to state A, and as noted elsewhere in the application, there is no remote treatment of patients in the prior art.

In additional to the health care providers 2a . . . 2g in the pool 1 not being able to communicate with one another, they are also not able to communicate with the patients 3a, 3b without intermediate steps. For example, but not by way of limitation, a patient 3a may have to make an appointment in order to receive diagnosis and/or treatment from the first health care provider 2a in the United States, and thus may not be able to receive treatment at a time when an appointment is not available, especially in non-emergency instances.

Further, when stationed overseas, it is not possible to make such and appointment, and for the above-mentioned reasons, it is difficult for a patient's 3b health care provider 2a to communicate with a health care provider (e.g., 2b in Britain). Thus, the patient 3b may receive an inadequate level of care, and harm may result due to increased time delay or cost in interfacing the patient 3b to an available health care provider 2b in the pool 1.

Also, due to varying standards and regulations, various health care providers 2a . . . 2g of the pool 1 may not be able to interface with emergency/hospital care 5 or pharmacy/drug store 7, thus further reducing the global availability of treatment For example, but not by way of limitation, the second patient may be stationed in a country having a different standard of medical care, where hospital and emergency treatment may not be standardized, and drug availability may be low. As a result, a life-threatening situation may result from an otherwise easily treatable condition if a patient does not have access to certain medication or services that provide the requisite treatment in the home country of the patient.

In the prior art system, clinical research organizations (CRO's) are created for the purpose of conducting clinical trials on new medical devices, procedures or pharmaceutical products awaiting regulatory approval for commercial use. The clinical studies involve selection of a study group of patients, who participate in the study and provide results to the clinical investigators conducting the study. In the prior art CRO, each CRO must solicit physician and patient participation, screen for qualification and oversee performance of clinical studies. These CRO functions are performed primarily on a person to person, telephone and paper basis.

Further, once the new medical treatment has been approved for experimental use, most physicians do not have access that would allow qualified patients to gain access to the benefits of the new medical treatment. As a result, qualified patients are denied access to participation in studies and/or obtaining benefits of those studies (e.g., new experimental drugs) due to lack of large-scale, coordinated access and also due tight controls on participation.

Presently, converging market factors include a large baby boom population of well-educated consumers having high demands for health care, along with a backlash against managed care, as seen in the class action lawsuits against HMOs, escalating premiums and employers looking for new strategies with regard to the self-funded population. Certain large self-funded employers, such as Xerox®, are providing vouchers to their employees for health care services and letting them develop their own customized health plans. Increasing questions about reimbursement present additional pressures on the industry. Hospital/physician integration initiatives have failed, as have physician practice management companies. Offloading risk to providers has also generally failed as a strategy for payors. As a result, there has been a significant movement away from risk-based compensation. In some parts of the country, capitation and risk pools are still in use. But in many ways, risk compensation resembles fee-for-service compensation in that the pressure is downward.

A prior art example is an Independent Practice Association (IPA) that had a provider participation contract with a managed care organization that included a full-service (primary care and specialty) physician service component along with hospital risk-based compensation. The managed care organization was bought by a national HMO, which renegotiated the terms of the agreement by demanding a primary care capitation arrangement in the low double digits per month. Although the level of compensation was grossly inadequate even when limited to primary care providers, these are the terms on which national payors are insisting. The process for negotiating risk-based compensation is no different from negotiating how much a payor will compensate a physician on a fee-for-service basis. As noted above, current physician reimbursement strategies then lock physicians into a paradigm in which physician income is based solely on the number of patients that can be seen or the number of procedures that can be done in a given day.

The Internet is becoming such a major new trend as both a delivery mechanism for e-commerce and content, as well as a very time efficient communications tool, which allows patients and physicians to be in more immediate communication on their own time, as distinguished from conventional telephone communication, where two people are simultaneously on the line. The possibilities are further demonstrated by the whole Internet business-to-business initiative and the growing receptivity to and applications for telemedicine, along with the creation of and movement toward the creation of electronic medical records and Internet security.

The Internet also makes disease management more efficient and affordable. Pharmaceutical companies and other health care entities are attempting to shift disease management functions from paper and telephone to the Internet as a much less expensive but as effective (or more) means than telephone or paper communications. The current physician community remains a very fragmented part of the market, and consumers ultimately have to go to their own physicians for health care. Doctors typically practice alone or in very small groups, and even highly paid specialists are under a lot of economic pressure with very limited time. The Internet initiative provides access to some major powerful, well-heeled players on the direct-to-consumer initiatives, particularly on content and care and treatment side of health care, as well as business applications for consumers and physicians, and a system that oversees and standardizes care and treatment via the Internet.

However, a key missing link in these developments is the actual treating physician and the interface between the business-to-business national players, the treating physicians, and the physicians' own patients. For example, if a patient visits Healtheon/WebMD™ on the Internet and gets information about health care and the consumer, the patient still needs to go back to his treating physician to actually apply that information (i.e., treatment) and to make the diagnosis and issue the requisite orders.

Thus, there remains an unfulfilled need for a system and method for creating an integrated medical network that efficiently and securely delivers health care.

### SUMMARY OF THE INVENTION

An object of the present invention is to provide a system and method for creating a community medical network through collection, distribution and use of information in connection with health care delivery.

Another object of the present invention is to provide a web-based information distribution system that supports the efficient and secure interfacing between treating physicians and their patients.

Another object of the present invention is to link national e-providers and sponsors with community physicians and their patients.

Another object of the present invention is to create virtual physician-driven organizations at the community level comprising a physician oversight mechanism and a network of Internet-linked physicians.

Another object of the present invention is to compensate physicians to manage care and, as medically appropriate, diagnose and treat patients in non-face to face environments.

Another object of the present invention is to compensate physicians continually to identify and integrate into community health care delivery systems standards of practice, protocols and non-face to face treatment, diagnosis and preventive health modalities.

Yet another object of the present invention is to provide a virtual clinical research organization (CRO) that can allow health care providers and patients to participate in clinical trials and gain access to new medical treatments.

To achieve these and other goals and objects, a method of delivering health care services in a networked environment is provided, comprising the steps of receiving a health care treatment request having at least one parameter from a user to a hosted environment, and transmitting said health care request from said hosted environment to at least one health care provider, and at least one of said health care provider and said hosted environment generating with the networked environment health care diagnostic, treatment and/or management instructions in accordance with said at least one parameter. The method further comprises providing at least one of said health care provider and said user with said health care diagnosis, treatment and/or management instructions, and remotely treating a patient in accordance with a standardized level of care.

Additionally, a hosted system that provides a patient with health care diagnosis, treatment and/or management is provided, comprising a sponsor network that determines at least one component of said hosted health care diagnosis, treatment and/or management and integrates said at least one component to generate at least one standardized health care diagnostic, treatment and/or management practice. The system also comprises a treatment network that conducts credentialing of health care providers, audits and monitors said hosted system and health care providers, and performs said health care diagnosis, treatment and/or management in a networked environment, further comprises a client enrolled in said hosted system and interacting with said health care diagnostic, treatment and/or management network through an user interface to provide said health care treatment and administration remotely from said health care providers in accordance with said at least one integrated component having said at least one standardized health care diagnostic, treatment or management practice, and facilitates audit oversight and administration of a health care finance and treating provider reimbursement for participation in the remote networked delivery system.

Further, a system that provides health care diagnosis, treatment and/or management to a patient is provided, comprising a request, generated by an user, received by an application service provider (ASP), said user request comprising a plurality of parameters, and an output to a health care network from said ASP, said health care network including at least one health care provider, that generates a health care diagnostic, treatment and/or management instruction transmission to said ASP. The system also comprises a treatment instruction output from said ASP to said user, wherein said health care diagnosis, treatment and/or management is performed remotely from said health care provider in accordance with at least one of said health care diagnostic, treatment and/or management instruction and feedback from said user.

Also, a method of performing clinical research is provided, comprising enlisting and administering provider participation in research projects, enrolling a patient in a hosted, health care network, generating a multigenerational family history in a profile of said patient in said health care network, identifying whether said patient is a candidate for clinical research, and conducting said clinical research with providers and patient in a networked, hosted environment.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1 illustrates a prior art health care system for diagnosing, treating, and managing patients;

FIG. 2 illustrates a health care system according to a preferred embodiment of the present invention;

FIGS. 3a and 3b illustrate a method for performing health care services according to the preferred embodiment of the present invention;

FIG. 4 illustrates a method of designing, building and managing health care services according to the preferred embodiment of the present invention;

FIG. 5 illustrates a method of creating and operation a clinical research organization (CRO) for a patient according to the preferred embodiment of the present invention;

FIG. 6 illustrates a method of creating and operating the CRO for a physician according to the preferred embodiment of the present invention;

FIG. 7 illustrates an overview of the architecture of the preferred embodiment of the present invention;

FIG. 8 illustrates the relationships between various entities and services according to the preferred embodiment of the present invention;

FIG. 9 illustrates the networks and functions of the preferred embodiment of the present invention;

FIGS. 10a and 10b respectively illustrate first and second phases of developing a community medical extranet according to the preferred embodiment of the present invention;

FIG. 11 illustrates a revenue model according to the preferred embodiment of the present invention;

FIG. 12 illustrates functions of various parts of the preferred embodiment of the present invention; and

FIG. 13 illustrates an exemplary disease management and prescription drug benefit program according to the preferred embodiment of the present invention.

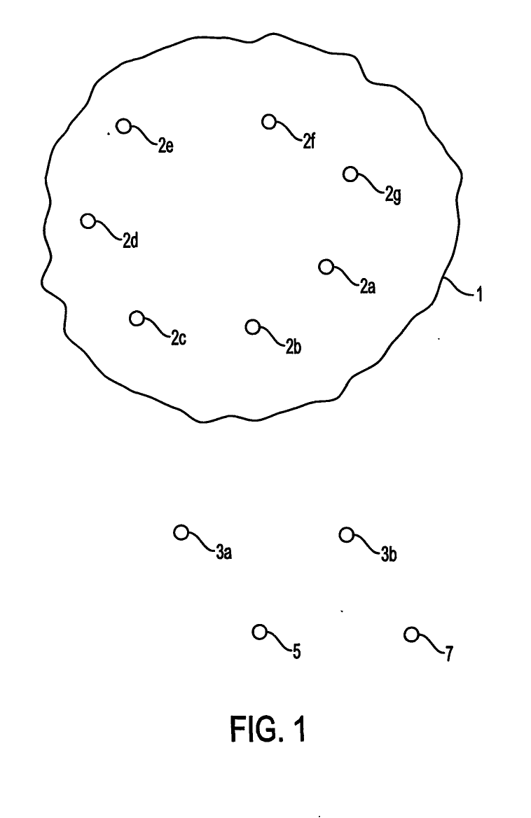

### DETAILED DESCRIPTION OF THE INVENTION

Reference will now be made in detail to the preferred embodiment of the present invention, examples of which are illustrated in the accompanying drawings. One of ordinary skill in the art can extend the tour package purchase system to other online product selection systems.

In the present invention, the terms are meant to have the definition provided in the specification, and are otherwise not limited by the specification. In this invention, the term “management” refers to a patient receiving care, instructions for obtaining care, or administration thereof.

To accomplish the aforementioned objects, the present invention includes at least the following features. An Internet health care delivery system is provided that includes non face-to-face health care. The term “health care” includes, but is not limited to, diagnosis and treatment, as well as disease, case and health management and other care not currently typically covered by insurers.

Additionally, a system is provided for the creation and management of electronic records using a universal standardized methodology, as well as physician-to-physician clinical care management Capabilities are provided to pharmaceutical manufacturer initiatives, including, but not limited to, pharmaceutical marketing, formulary positioning and pull through (e.g., direct to-consumers and direct to physicians (online detailing)), as well as drug compliance programs.

Also, the present invention includes provider network rentals and customized configurations (local licensure rented for consultations), Internet-based provider credentialing and provider quality oversight.

In the present invention, internet health care financing is conducted so as to maximize benefit design, optimize payment for premiums/subscriptions, and easy management of medical savings accounts. In the present invention, a patient can perform comparison shopping for specific health care procedures and health care packages, and the present invention includes online organization of/shopping by group purchasing organizations.

Other aspects of the present invention include, but are not limited to, formation of online clinical research organizations (CROs), data warehousing, and specialty networks and products.

The system of the present invention, the preferred embodiment of which is referred to as MedComUnit-e™, is a web-based integrated medical network that efficiently and securely collects, distributes, and uses information in connection with health care delivery.

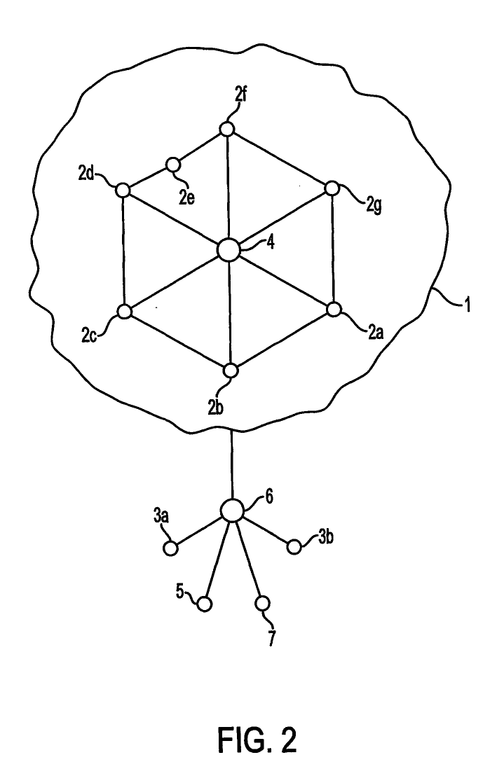

In the present invention, an Application Service Provider (ASP) is located in a hosted environment, and performs independent delivery of health care services to the patient and the health care provider. As illustrates in FIG. 2, the ASP includes a health care provider network 4 and a sponsor network 6. The health care provider network 4 is coupled to participating health care providers 2a . . . 2g in the pool 1, and is coupled to the sponsor network 6, which also commonly interfaces with the patients 3a, 3b, the emergency care network 5, and the supply network (e.g., medication and medical devices) 7.

The sponsor network 6 identifies the necessary components of an internet health care delivery system (e.g., but not limited to hardware, hand-held devices, software, disease management programs, and insurance companies), and outsources those components by issuing requests for proposals (RFPs), negotiating contract terms with qualified bidders and managing the contractual arrangements. The sponsor network 6 also integrates each of the components into an internet health care delivery and reimbursement system, and manages that system.

The health care provider network 4 organizes and administers treating physicians in each community as an internet network or medical staff Either directly or on behalf of a health system, MC provides the credentialing and physician participation requirements, relevant bylaws and rules and regulations and conducts peer review, medical audits and outcomes studies. In order to participate in the internet medical staff or network, physicians must agree to incorporate the medical standards of practice, protocols, electronic medical record functions and medical management systems into their office and hospital practice. MC maintains the electronic medical records.

The sponsor network 6 develops and administers a financial reimbursement/compensation system for treating physician participation in the internet delivery of health care. In addition, MC operates the administrative functions, e.g. eligibility determinations, insurance claim submissions, appointments, patient care communications, via the internet.

The ASP enrolls patients into the internet health care delivery system. The sponsor network is the central control for all patient internet communications. For example, but not by way of limitation, the sponsor network 6 designs and maintains drop down, point and click patient communications that incorporate the standards of practice and protocols for the internet care health delivery system. In addition, the sponsor network 6 develops and administers the health care financing systems for patients participating in internet health care delivery system as well as patient incentive programs. Patients can pay out of pocket and use a shopping cart approach or medical savings plans or health care benefits are adapted to cover the internet health care delivery system.

Additionally, the patient 3a, 3b may attach medical devices to interface with the sponsor network 6. The medical devices may include, but are not limited to, thermometers, sphygmomanometers, scopes with cameras controllable by the health care provider and/or sponsor network, blood testing devices (e.g., glucose meter or white blood cell count), pallor indicators, or similar devices that can provide an analog or a digital signal to said sponsor network that can subsequently be used to makes treatment, diagnosis, and/or management decisions.

Because the patient can be treated by their licensed physician independently of physical location, the present invention overcomes at least the prior art problems and disadvantages of language, protocol and currency barriers. Further, the medical devices applied by the patient (which may be delivered by a delivery service if the patient does not own any medical devices) permits completely virtual medical health care, where the quality of service is better than in-person health care, due to the reduction in time delay and the elimination of costly non-standardized practices.

Similarly, the medical devices may also be operated based on a command from the health care provider. Such medical devices include, but are not limited to, metered medicine dispensers having an electronically adjustable rate, robotic devices to perform remote surgery, or other interactive devices to treat patients remotely.

To overcome various problems and disadvantages of the aforementioned prior art systems, the preferred embodiment of the present invention standardized at a global level across language, currency, health care access network, and medical care protocol.

The preferred embodiment of the present invention creates an infrastructure that will support and foster, creation of a secure electronic medical record (EMR), integrated with state of the art information and human expertise/support regarding medical conditions, treatment and diagnosis. Patients may have personalized websites at which their entire health/medical history is stored that can be accessed from any remote site. For example, but not by way of limitation, as gene mapping becomes an integral part of a patient's medical record, the information would be stored at the individual's personal health care. The information includes family histories, including parents' genetic maps and health histories. Because of the standardization of communication regarding the patient's care and treatment, the patient can be assured that at all times, all relevant information is maintained and can be accessed on a world-wide basis as needed.

Not only is the information maintained on a standardized basis, if a patient needs to access information out of the country, there is a common language and code so that foreign physician knows how to access/understand and treat the patient. The patient's care and treatment will be incorporated as a standardized international language.

Based upon the internet health care system, patients can readily access their EMR from any place in the world, and health care providers can be integrated into standards of care and protocols on a worldwide basis. Accordingly, patients traveling abroad can maintain ongoing communications with their community treating physicians regarding health care matters, access their own personal medical records, and document any health care episode in a standardized fashion in their records. For example, but not by way of limitation, global standardization offers great potential for U.S. military families and other non-military personnel living abroad.

The preferred embodiment of the present invention can include networks of providers in other countries. Initially, foreign providers could provide care and treatment to U.S. enrollees. The preferred embodiment of the present invention would advise foreign providers not only of pertinent patient health care information, but would also give them access to the standards of care and protocols regarding care and treatment of the U.S. enrollees. When the present invention is used outside the U.S., it can create networks of providers linked via the Internet into a global Internet health care delivery system. As a result, health care treatment and management knowledge extent outside the U.S. can be incorporated into the Internet health care delivery system. In addition, the ability to collect and collate standardized data will permit creation of integrated databases for research, documentation and validity of other health care treatment modalities.

The globally standardized internet health care delivery system would become the gateway for the implementation of new health care technologies. For example, but not by way of limitation, if a new technology is developed to monitor and/or treat a chronic health condition, the present invention can incorporate that technology in a standardized fashion and, via the Internet, educate patients and treatment providers regarding its availability and applications. In addition, because of the integration with the health care finance mechanism, the present invention can facilitate the design of the optimal health care finance mechanism to integrate the new technology in the most cost efficient manner.

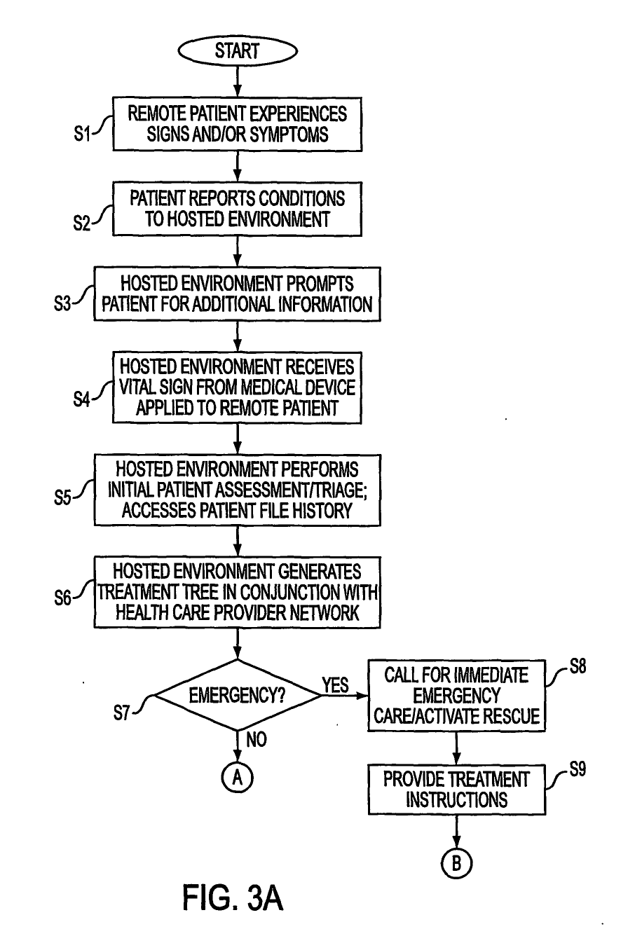

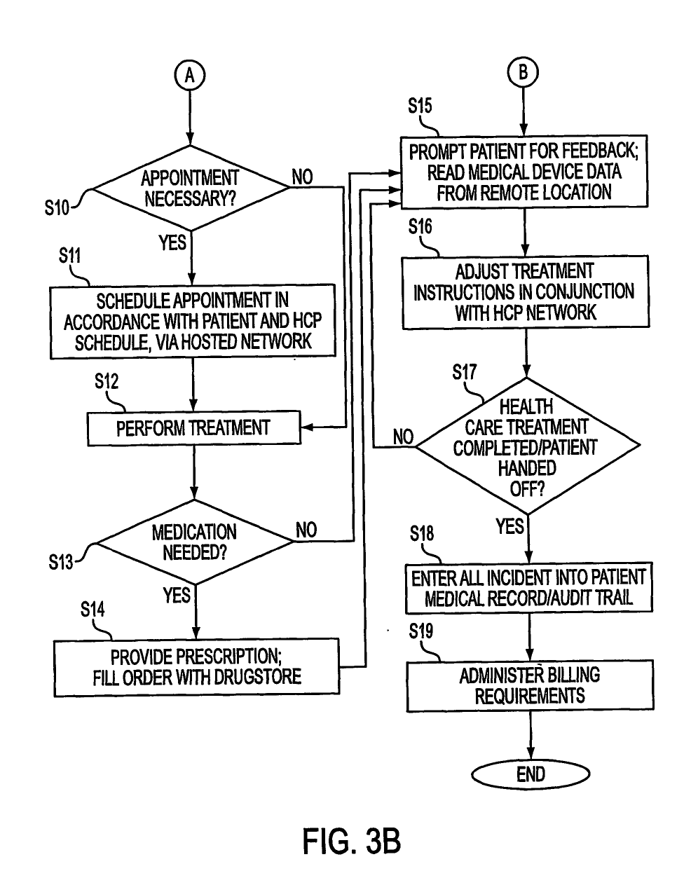

FIGS. 3a and 3b illustrate a preferred method of operating the preferred embodiment of the present invention. In a first step S1, the remote patient (i.e., substantially not in the presence of a health care facility) experience signs and/or symptoms indicative of a need for medical treatment. The signs and symptoms may include, but are not limited to, fever, nausea, high blood pressure, pallor, dilated pupils, chest pain, difficulty breathing, and/or the like.

In a second step S2, the patient reports the aforementioned conditions to the hosted environment (i.e., sponsor network). The communication can be via land line or wireless communication, and may include a global positioning system (GPS) to determine location, especially if a hand-held communication device is used in the field. The reporting can take place via a computer (e.g., Internet, Extranet or private network).

In a third step S3, the hosted environment prompts the patient for additional information in order to make a more accurate diagnosis. In the next step S4, the hosted environment may also request the attachment of a medical device to the remote patient to obtain more detailed information on vital signs and/or symptoms. For example, but not by way of limitation, the hosted service may instruct the patient to wear a sphygmomanometer (i.e., blood pressure monitoring device).

After receiving the inputs regarding the patient signs and/or symptoms, in step S5, the hosted environment performs initial patient assessment (e.g., triage), and accesses the patient file history. In the next step S6, the hosted environment generates a treatment tree, including at least one treatment instruction. The treatment tree may be generated in conjunction with the health care provider network. Alternatively, because the physician has licensed the hosted environment to perform the treatment, the hosted environment may perform the treatment directly, depending on the preference of the health care provider and/or patient.

Then, in the seventh step S7, the hosted environment determines whether the present medical condition of the patient constitutes an emergency. If so, then the Emergency Medical Services (EMS) network is activated by calling for immediate emergency care (i.e., dial 911) in the next step S8, and then in a following step S9, the patient is provided with emergency treatment instructions, to be performed while waiting for emergency care to arrive.

If there is no emergency, then it is determined whether an appointment is necessary. That determination may be made by the patient, hosted environment, and/or health care provider. If an appointment is required, at step S11 the hosted network schedules an appointment in accordance with the health care provider schedule. If the patient's primary health care provider is not available, the patient will be given a series of backup options, all conforming to the same level of standardization as the patient's primary health care provider. If no appointment is required, then step S11 is skipped.

Next, at step S12, treatment is performed. The treatment may be remote, using the above-described medical devices to perform remote surgery, administration of medicine or the like, or the treatment may be in-person if an appointment was scheduled. After treatment has been performed, step S13 determines whether medication is needed, and if so, automatically fills the prescription in step S14 and if desired by the patient, arranges the delivery or pick-up options with a local medicine retailer (e.g., pharmacy).

After completing steps S13 and S14, or alternatively, step S9, step S15 is performed. At step S15, the hosted environment prompts the patient for feedback, and the patient transmits a feedback signal or message to the hosted environment The feedback signal or message can include, but is not limited to, a reading of any medical devices attached to the patient, descriptions of patient condition, or reports on results of treatments administered The feedback may also include a report from EMS personnel that the patient is in their care. Then, in step S16, the hosted system adjusts the treatment instructions in accordance with the health care provider network, based on the feedback from step S15.

At step S17, the hosted system determines whether health care treatment has been completed, or if the patient has been “handed off” to another health care system (e.g., EMS feedback for emergency patients). If not, steps S15-S17 are repeated until the answer is “YES”. If so, then all incident information is entered into the electronic medical history, so as to append the audit trail and the patient information for more accurate future treatment, at step S18. Step S18 is standardized. In step S19, the billing requirements (e.g., insurance payment) are administered, to complete the online process.

In a first example of the preferred method illustrated in FIGS. 3a and 3b, a patient logs onto their personalized website using the patients' personal code with allergy symptoms. The patient provides the necessary information through screens that incorporate the standard of practice and protocols related to allergies to the sponsor network. The information provided by the patient is correlated with the patient's medical record and history for past episodes, drug reactions, etc. In accordance with nationally recognized standards of practice, the patient is offered treatment options, e.g. over the counter or prescription treatment options along with the costs to the patient based upon the patient's pre-established personalized health care finance system (e.g. prescription drug co-payment or generic options). The patient selects the treatment preferred (e.g. a prescription drug). The sponsor network routes the communication to the patient's designated treating physician (e.g., treating network) along with any supporting information (e.g. pollen count or abstract or recent article, drug therapeutic information, for authorization or other intervention).

If the physician authorizes the prescription, it is electronically transmitted to the participating pharmacy designated by the patient. The pharmacy delivers the drug by mail or otherwise to the patient. The patient receives confirmation that the drug has been ordered, the expected time of delivery, and the patient's account is debited or credit card is charged, as applicable. This interaction becomes a part of the patient's electronic medical record.

In another example of the preferred method illustrated in FIGS. 3a and 3b, a patient accesses the system in the middle of the night to report crying baby with a temperature of about 102 degrees Fahrenheit. The patient is advised likely ear infection, flu, etc. and is advised regarding symptom management and of things to watch for if conditions worsen. The system schedules appointment with child's pediatrician during early morning sick child appointments and patient is notified that the appointment is confirmed. Throughout the evening, the system is available to interact with patient as needed. The interaction becomes part of the medical record.

Further, the same child may have chronic ear infections as documented in the electronic medical record. The mother maintains scope to inspect ear at home connected to camera hooked to computer. The child may wake up in the middle of the night with symptoms. At that point, the mother enters symptoms into system and puts scope in child's ear and transits picture along with symptoms. The sponsor network correlates information, confirms that the condition is an ear infection, and orders antibiotic for delivery to home. The mother is advised of those developments. The entire process is done via the internet, and incorporated into the patient's medical record. The treating physician is also advised. The mother may receive e-mail reminders regarding follow up (e.g. reminders to take all of medicine as prescribed, related information, dangers of not taking all of medicine). If condition worsens, the mother is advised that a physician visit is needed and appointment is scheduled electronically.

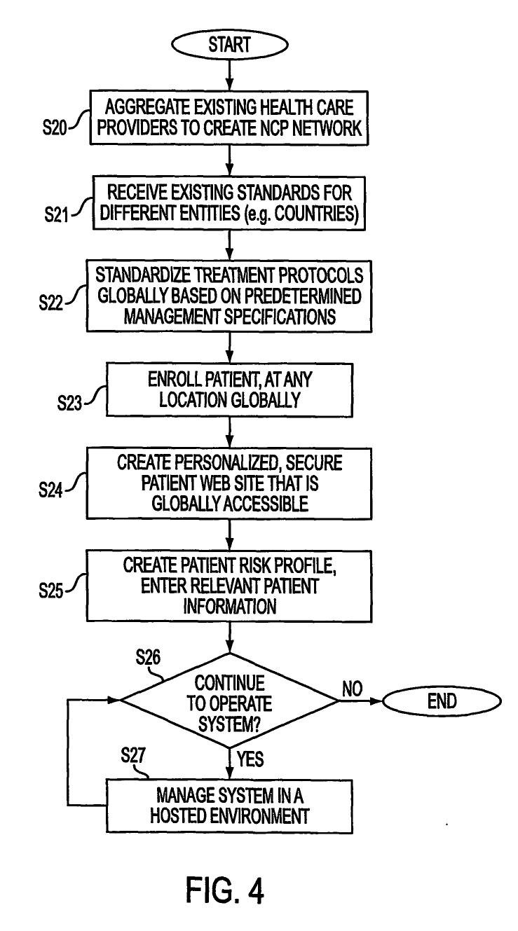

FIG. 4 illustrates a method of designing and developing the hosted environment according to the preferred embodiment of the present invention. In a first step S20, existing health care providers, which are independent and disaggregated in the prior art system, are aggregated into a large-scale health care provider network. In step S21, the standards for different systems and countries are received, and at step S22, treatment procedures are standardized globally, based on predetermined management specifications. The global standardization includes, but is not limited to, diagnosis, management, health care access, and treatment protocols. Step S21 includes populating the hosted environment with the necessary data.

After step S22 has been completed, the system is operations, and a patient can be enrolled at any global location, as is done in step S23, which may be accomplished by wireless or land line communication of any type. At step S24, a personalized secure patient interface is created (e.g., web site), such that patient can access the web site from any location in the world. Further, at step S26, it is determined whether to continue to operate the system. If so, the system is managed in the hosted environment in step S20, for use in accordance with FIGS. 3a and 3b.

In an example according to the preferred method illustrated in FIG. 4, a payor determines that it will fund online prescribing and internet disease management programs. The sponsor network develops the specifications for the disease management program and online prescribing infrastructure provider and solicits bids. The sponsor network then negotiates and enters into contracts with the program sources and manages contract operations, and establishes reimbursement levels to the relevant treating physicians, e.g. primary care, pulmonologists, etc. and communicates with the participating physicians about the programs and reimbursement procedures. Next, the sponsor network enrolls the patients and incorporates the online prescribing and disease management protocols and standards of practice into the internet delivery system.

The sponsor network also administers the payments from the payor to the physicians and other participants, and maintains the electronic medical record of all internet interactions for each patient and provides reports, conducts oversight and other activities that are part of the overall program. Payor determines that it desires to provide patients with incentives to participate in these programs. Further, the sponsor network administers the patient incentive program. For example, but not by way of limitation, the patient earns points for activities that support the programs, e.g. tracking diet, attacks, use of medications, and can earn rewards for the participation. MC documents compliance and tracks the patient's rewards.

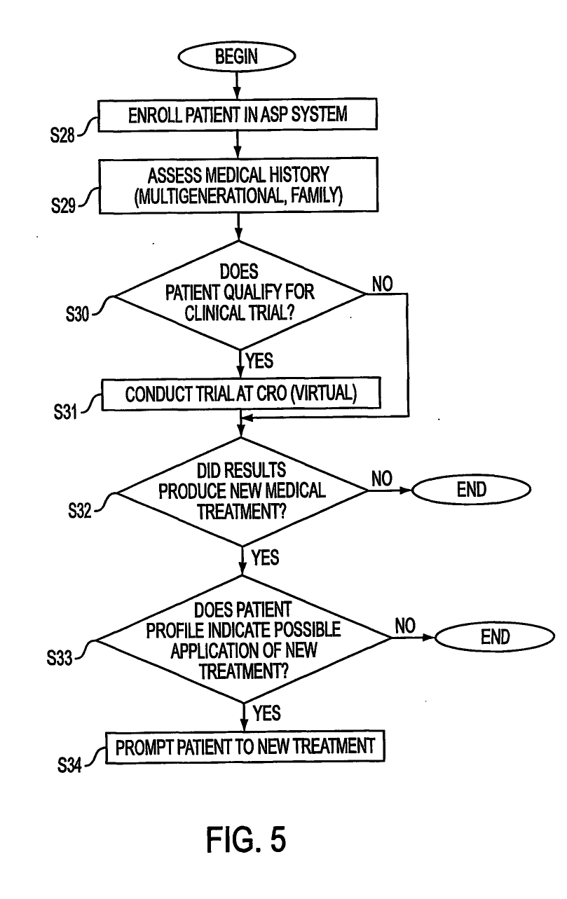

FIG. 5 illustrates a method of creating a virtual clinical research organization (CRO) according to the preferred embodiment of the present invention. In step S28, the patient is enrolled in the above-described health system according to the preferred embodiment of the present invention, as illustrated in FIG. 2. Then, in step S29, multigenerational family history is assessed from the EMH of the patient, such that genetic information of previous generations on various conditions (e.g., heart disease, high blood pressure) is readily accessible to permitted users, and the database of enrollees is screened to identify qualified potential candidates.

Next, at step S30, it is determined whether the patient qualifies for participation in a clinical trial. This determination can be based on the EMI as well as current treatments being administered to the patient. For example, but not by way of limitation, if the patient is experiencing depression, and there is a clinical trial for depression patients, a treating physician may determine that the patient is qualified at step S30. If so, and the patient agrees to do the study, then the trial is conducted by the CRO at step S31. The trial will use the standardized information and protocols generated in the preferred embodiment of the present invention.

Regardless of whether the patient participates in the trial, it is determined by the CRO in step S32 whether the clinical trial has produced a new medical treatment If so, then in step S33, the hosted environment can automatically determine that the patients qualify for the new medical treatments based on their EMH and the new medical treatment requirements. If the patient qualifies and the treating physician authorizes the treatment, then the patient is offered participation in the new treatment at step S34. The prompting may take place via the hosted environment or the treating health care provider.

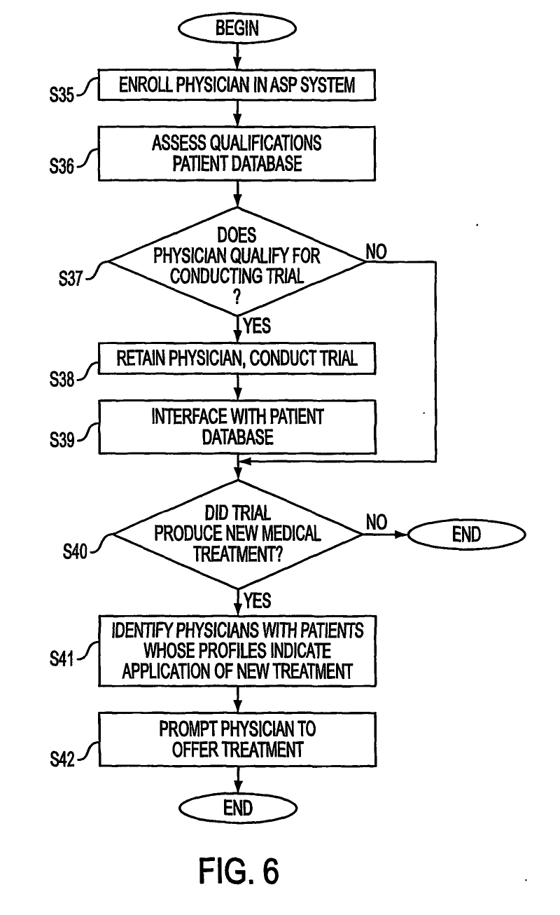

As illustrated in FIG. 6, the virtual CRO concept also applies to the physician. In a first step S35, the physician is enrolled in the ASP system (i.e., hosted environment). Then, at step S36, the qualifications of the physician and their patient database are assessed. In a next step S37, it is determined whether the physician qualifies for conducting a trial. If so, step S38 is conducted, wherein the physician is retained and the trial is conducted, followed by step S39, during which the ASP interfaces with the patient database.

If the physician does not qualify at step S37, or alternatively, after step S39 is completed for a qualifying physician, it is determined whether the trial produced a new medical treatment at step S40. If so, then at step S41, the ASP identifies physicians having patients with profiles that are indicative of qualifying for application of the new treatment. Next, at step S42, the physician is prompted to offer the treatment to the patient.

The present invention uses the Internet to integrate together the community of treating physicians, to integrate this network of treating physicians with their own patients, and to interface this community of Internet-based treating physicians and their patients (Community Medical Extranet™) with the Internet health content and business-to-business companies. In completing this integration, it becomes possible to use the Internet in actually delivering health care. One of the current limitations to this application is that treating physicians are currently compensated only for face-to-face patient care, so that they have little reason to consider different ways of taking care of patients. In addition, as a result of the current reimbursement system, there is managing the continuum of care for patients. Currently, consumers are required to navigate the health care system on their own but are not empowered to do so, and these difficulties are combined with the reality that, on their own, clinical decisions are largely driven by the reimbursement system. Again, however, the current health Internet initiatives are merely pre-set formats with a lot of general information. Consumers can spend hours on the Internet trying to sift through various health care sites to get meaningful information that applies to his or her own situation, but their own caregivers are not in the loop and the health insurer is generally viewed as an adversary. Further hampering the situation are other factors: health care systems are financially strapped and are not pursing new initiatives; e-content and commerce companies lack a national sales force to reach the fragmented physician community; physicians lack the time or resources to incorporate Internet communication at the doctor's office and, without compensation, have little incentive to do so.

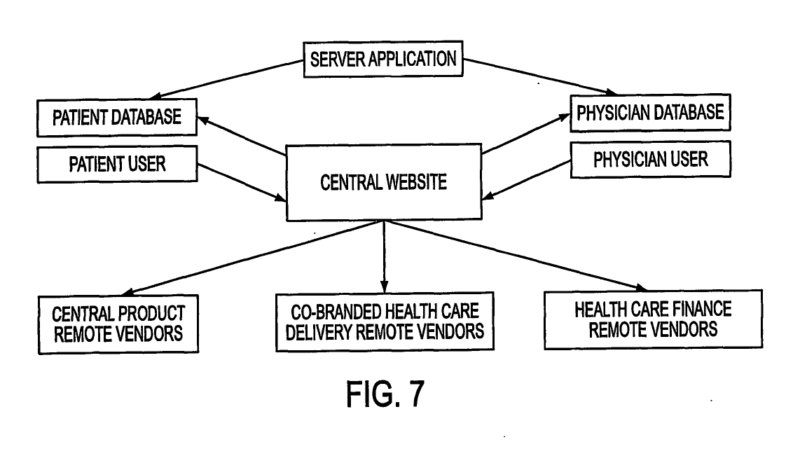

FIG. 7 illustrates an overview of the system architecture according to an alternative preferred embodiment of the present invention. A central website is coupled to a patient database and a physician database, such that the patient and physician can communicate with one another via the central website. Further, a server application links the physician database with the patient database. Additionally, the central website is coupled to central product remote vendors, co-branded health care delivery remote vendors and health care finance remote vendors.

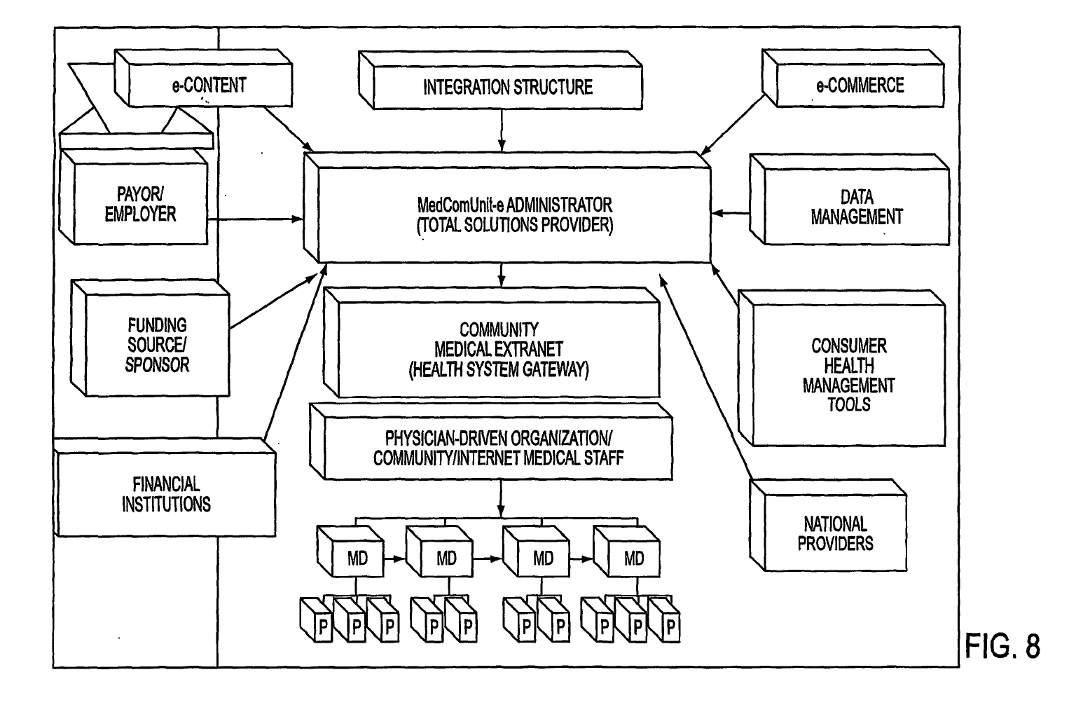

FIG. 8 illustrates the physician-driven organization, which is described below in greater detail and is an alternative preferred embodiment of the present invention. A total solutions provider (TSP) receives inputs from e-commerce and/or e-content sites, data management, consumer health management tools, national providers, financial institutions, funding sources and/or sponsors, payors and/or employers, and an integration structure site. The TSP generates an output to a community medical extranet (i.e., health system gateway), which interfaces with a physician-driver organization (PDO). The PDO includes community and/or internet medical staff, and is linked to health care providers (e.g., physicians), who are in turn linked to patients.

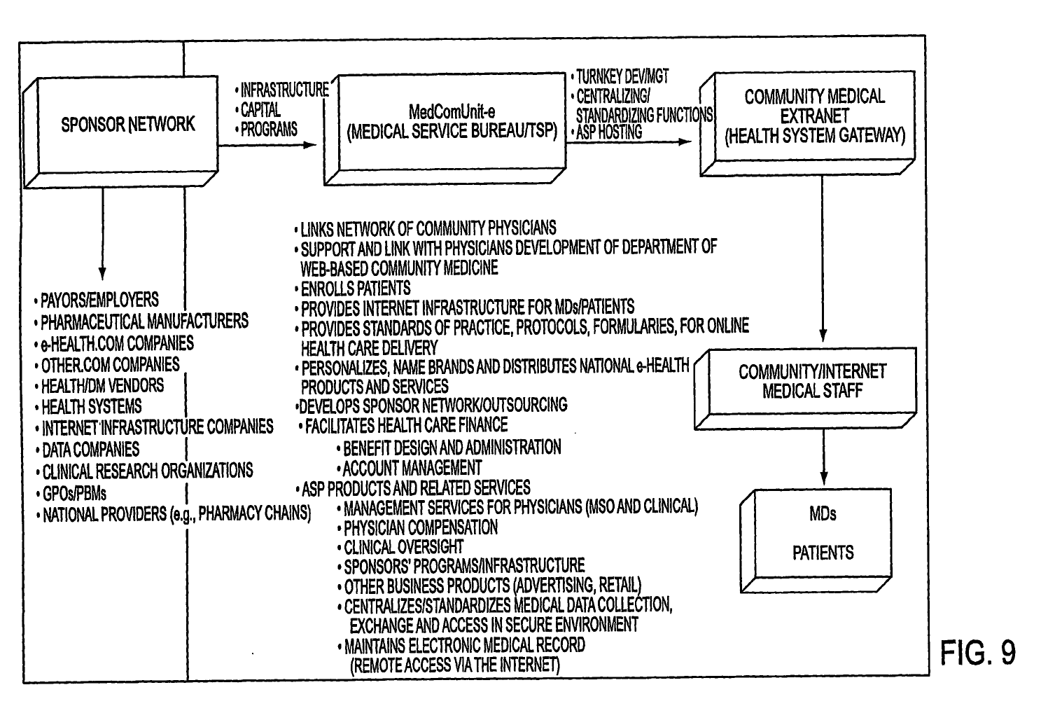

FIG. 9 illustrates an alternative preferred embodiment of the present invention. The sponsor network includes payors/employers, pharmaceutical manufacturers, online health companies and other online companies, health vendors and health systems, intranet infrastructure companies, CRO's and national providers. The hosted environment links the network of community physicians, as well as supporting and linking with physicians development of department of web-based community medicine. Further, the hosted environment enrolls patients, provides an internet infrastructure, standardizes online health care delivery, and personalizes and brands national health products and services. Also, the hosted environment facilitates health care finance, and provides ASP products and related services, including, but not limited to, compensation for health care providers, clinical oversight, and maintenance of electronic medical histories.

The hosted environment is coupled to the community medical extranet, which is coupled in turn to the community/internet medical staff, which is in turn coupled to the physicians and patients.

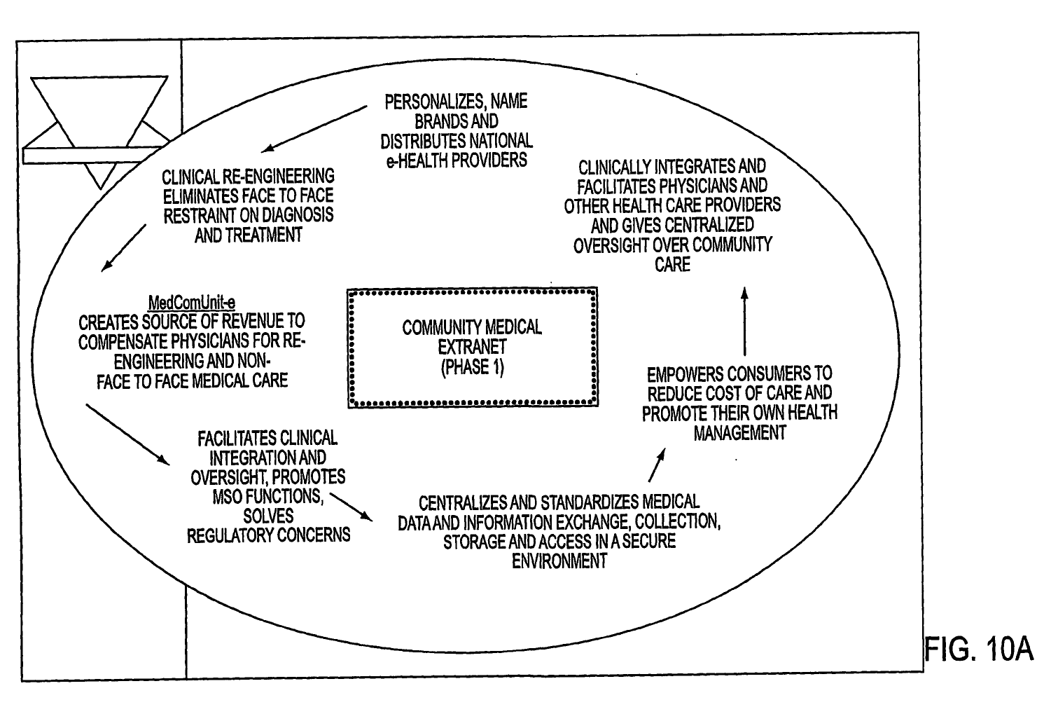

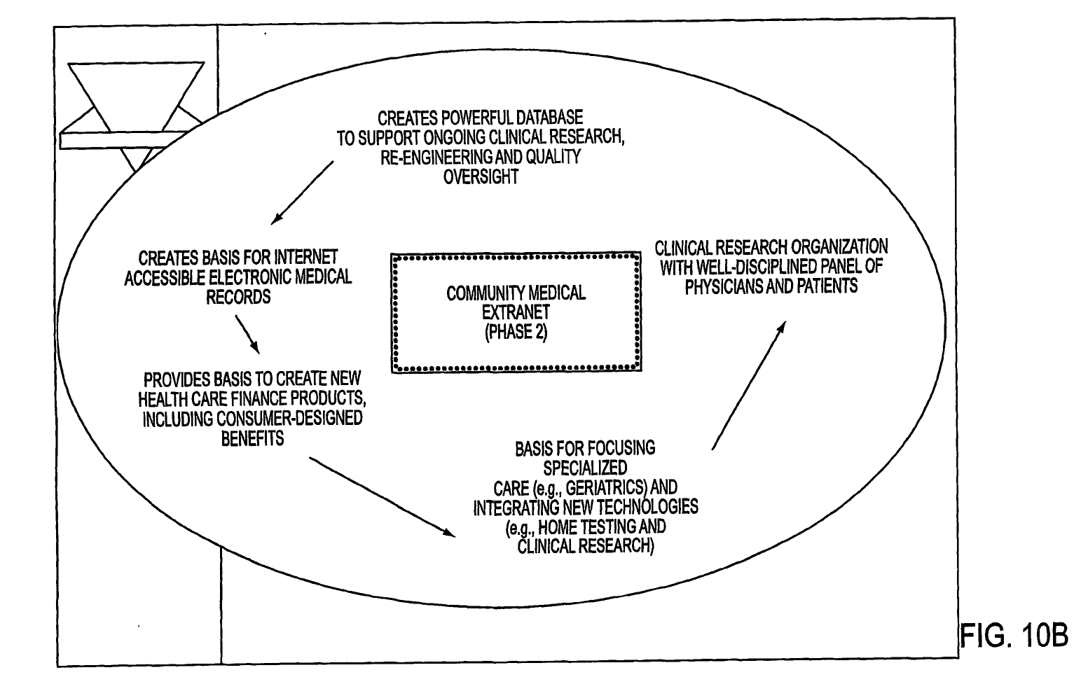

FIGS. 10a and 10b describe the necessary steps in phase 1 and phase 2 of the community medical extranet, respectively. In FIG. 10a, phase 1 begins with personalizing, branding and distributing national e-health providers, followed by clinical re-engineering to eliminate face-to-face restraint on diagnosis and treatment Then, the hosted environment creates a source of revenue to compensate health care providers for remote treatment and re-engineering, followed by facilitating clinical integration and oversight (including regulatory concerns). Next, medical data is standardized and centralized, as well as collected and stored in a secure environment, which is in turn followed by empowering consumers to reduce the cost of care and promote their own health management. At the end of phase 1, the hosted environment clinically integrates and facilitates physicians and other health care providers and provides oversight for community care.

In phase 2, as illustrated in FIG. 10b, a database is created to support ongoing clinical research and quality control, followed by creating the basis for internet accessible electronic medical records. Then, a basis is provided to create new health care finance products (e.g., consumer-designed benefits), and that step is followed by a basis for focusing specialized care and integrating new technologies. Finally, phase is completed with the step of a CRO with a well-disciplined panel of physicians and patients.

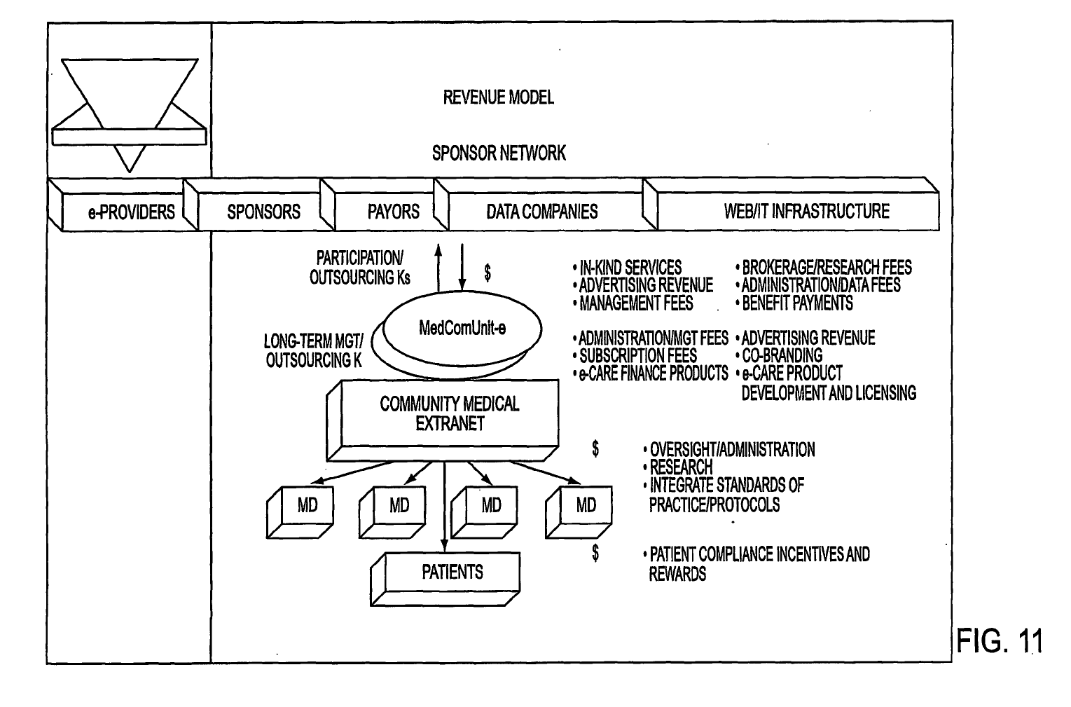

FIG. 11 illustrates a revenue model according to the preferred embodiment of the present invention, which is described in greater detail below. A hosted environment includes a sponsor network that includes e-providers, sponsors, payors, data companies, and includes the web and information technology infrastructure. The hosted network interfaces with the community medical extranet, which interfaces with physicians and patients. The revenue model provides patient compliance incentives and rewards, as well as financial incentives to physicians for oversight/administration, research, and integration of standards of practice and protocols. The hosted environment revenue includes sales of products, advertising revenue, co-branding, subscription fees, and product licensing. The revenue model further includes in-kind services, advertising revenue, management fees, brokerage/research fees, benefits payments and administration/data fees.

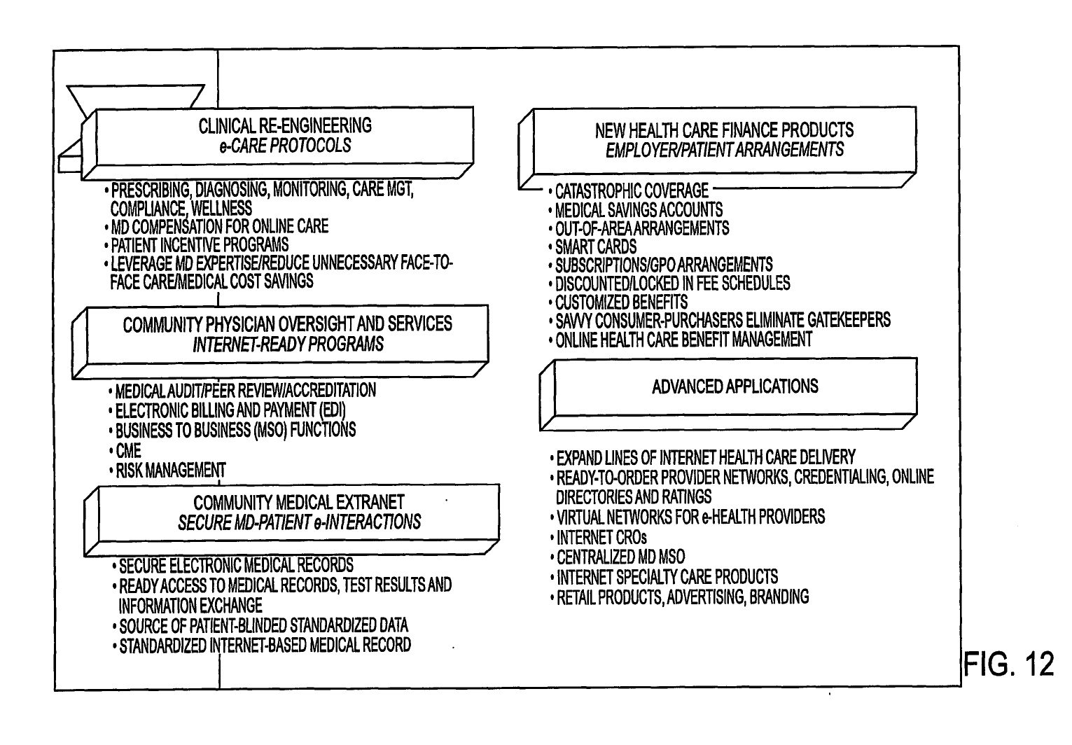

FIG. 12 illustrates various types of functions performed by various preferred embodiments of the present invention. The main categories include clinical re-engineering, community physician oversight and services, community medical extranet, new health care finance products, and advanced applications.

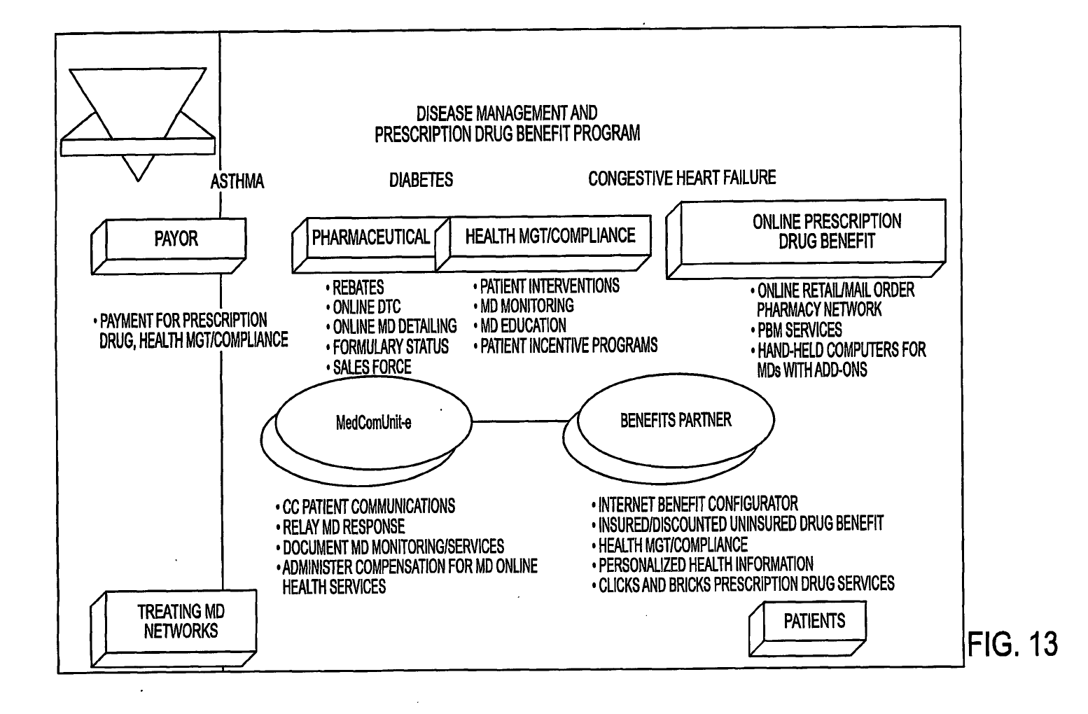

FIG. 13 illustrates another preferred embodiment of the present invention, which discloses a disease management and prescription drug benefit program. A payor pays for prescription drug and health management/compliance. A pharmacy includes rebates, online sales and advertising, formulary status and a sales force, whereas health management and compliance includes patient intervention, monitoring and education of physicians and patient incentive programs. Further, an online prescription drug benefit is provided, including hand-held computers for physicians with add-on medical devices. The hosted environment and the benefits partner interact to provide the treating physician network and patient with various financial and administrative services, as illustrated in FIG. 13.

There are many players who have a lot of interest in helping to create an infrastructure from which to launch these initiatives. For example, certain pharmaceutical companies' key marketing strategies are based upon the Internet, not primarily because they want to generate revenues via the Internet, but to maintain direct access to doctors and consumers to support their core business of developing and selling pharmaceutical products.

There are some extremely powerful information databases in existence that serve as extraordinarily predictive marketing tools. For example, every manner in which consumers use a discount card is amassed along with all the other information databases out there so that a consumer can be profiled as, for example, being a certain age, owning a motorcycle, living in a certain neighborhood, and having a certain kind of job. It can then be predicted fairly accurately the way someone is going to interface with a particular system.

While there is a market for companies such as Healtheon™ in terms of physician-to-physician and physician-to-consumer and consumer-to-consumer education, these initiatives become much more viable if a sufficient number of treating physician and consumer participants are linked on a secure platform via the Community Medical Extranet.

The problem, however, is that a doctor may sign up for the service because the subscription is free, but the reality is that physicians do not have the time to review e-mails from their patients, nor are they compensated for doing so. Moreover, the potential liability for having e-mails being received by the physician without providing substantive responses is tremendous. In the end, it merely adds another layer of work on a physician and, because the physician community and health care system is so fragmented and disorganized, it does not improve health care significantly or save costs.

In light of these considerations, one of the primary challenges is to find the right incentive for meaningful physician participation.

The core concept of the present invention is the creation of a truly integrated physician community in conjunction with secure portals to create a virtual or actual organization at the community level that provides the infrastructure to link the physicians to the organization cost effectively. The market requires that physicians be compensated to manage health care and, as medically appropriate, diagnose and treat patients in non-face-to-face environments. This challenge of creative physician compensation requires identifying continually standards of practice, protocols and non-face-to-face treatment diagnosis and preventive health modalities. As an example, the treating physicians themselves must set the standards that indicate there really are no side effects for allergies so that a physician can always telephone to a pharmacy a prescription for allergies or e-mail a prescription for allergies to a patient who wants it any time. This example should be distinguished from a prescription for erectile dysfunction, where a patient should have a physical and a blood pressure checked, or not have certain symptoms, which could be confirmed via the Internet on the patient's electronic medical record, resulting in the physician calling in a prescription for it. This exemplifies the form of clinical re-engineering that the present invention encompasses. The re-engineering is delivered through a Community Medical Extranet™ focusing on medical staffs or large health systems as the best access point, where the physicians are somewhat organized and focused on giving care (rather than medical societies that are much more political entities).

Once the physicians themselves utilize the Internet and are interfaced with other physicians and patients, who are linked to all of the health content companies, a physician-driven organization ADO) permits treating physicians to learn about the kinds of inquiries put forth by patients so that meaningful responses can be coordinated and marshaled. Once the secure Community Medical Extranet is created, the next step is re-engineered health care delivery financing.

The functions of the Community Medical Extranet include the role of distributing to national e-health providers and others, not just limited to the Internet. It has the potential to create a source of revenue to compensate physicians for the re-engineering and non-face-to-face patient time. In addition, it facilitates the clinical re-engineering to eliminate physicians' current face-to-face strain upon diagnosis and treatment. It also facilitates the pooling of resources as well as the care and integration concept so that physicians are really interfacing with each other. It also results in patients being better directed about how to access the system. For example, if a patient believes that her finger is broken, she does not first go to my primary care doctor, she immediately is directed to see the orthopedist and to also have X-rays taken and one for treatment provided and that is the end of it. It would also create the basis for centralizing and standardizing the collection and exchange of medical information, given that clinical re-engineering entails physicians creating and maintaining medical records in a more standardized format and reporting the appropriate key information so that the information can be pooled, sorted, and examined much more effectively. Because it has a strong consumer component, this approach will empower consumers to be much more effectively proactive in their care and treatment. This result would be better for purchasers and provide the opportunity to clinically integrate and facilitate physicians and others in playing a role, not merely in providing direct treatment but in the overall management and integration of care.

Additionally, because it will then be possible to customize the present invention to specific components of a particular patient base, it can be implemented to focus on specialty care, such as geriatric, pediatric, and periology. This also permits the creation of a tremendously powerful clinical research organization with an infrastructure that is already in place. Once there is established a disciplined, coordinated and standardized panel of physicians and their patients, it is possible to identify potential enrollees, effective self-reporting, and good receipt of the data.

National pharmaceutical companies, for example, are interested in developing knowledge about and supporting treatment of certain medical conditions or disease states through an Internet driven disease management tool interacting with physicians and patients. Such an approach can reduce the number of patients in the emergency room and keep people healthier and much more satisfied with their quality of life; however, there is no reimbursement system in place to support it. From an e-provider's perspective, the physician-driven organization of the present invention will customize and program e-products and services offered through the next generation's health system. The product of the present invention will be offered at the treating physician and consumer level by individual medical community identifiers so that patients are able to appreciate that the product relates to their personal health. This represents a very powerful distribution network. In return, the physician-driven organization receives a percent of the advertising revenues or other payment streams that are generated.

Medical centers and hospitals risk financial destruction by not participating in such an approach. Hospitals today are often limited to hospital services. Many have been forced to terminate employment relationships with physicians. According to a preferred embodiment of the present invention, one function that a health system supported PDO would serve is as a clearinghouse for physician communications. In addition, the PDO would have the capacity to sort through and distribute throughout the community new developments and opportunities. In order for the product to be a viable investment, the system in place must ensure that the tools are being effectively used as a meaningful communications and delivery mechanism.

The PDO provides oversight to ensure that the tools are implemented and for the physicians' benefit, by organizing physicians to work collaboratively. It is a business-to-business function, as well as a research and development resource regarding new applications and redefined services and sources for re-engineering health care delivery. It has the capacity to validate and integrate new national products and vendors, such as Healtheon™ and Dr. Koop™.

There are many different ways to generate revenues from this model. According to a preferred embodiment of the present invention, one approach is to offer a national network of vendors whereby MedComUnit-e assembles the participants for participation through the Community Medical Extranet. In addition, there is the potential for providing in-kind services, providing incentives to physicians using the Internet and sharing the revenue advertising. The present invention increases the advertising potential through increased number of web site visits, along with management fees, brokerage research fees, administrative fees, and data licensing for disease management and other purposes.

MedComUnit-e organizes the entire system and has a turnkey monitoring management contract with an individual Community Medical Extranet to implement the present invention. The present invention serves as an Internet PPO (preferred provider organization) offered at the Community Medical Extranet level through the administrative functions of MedComUnit-e. This Internet PPO approach effectively eliminates one of the primary impediments to integration at present: the unlicensed practice of medicine. The present invention removes the problem because the treating physician is making the decision. As a result, the patient is able to obtain a prescription by sending an e-mail request to the pharmacy for mail order delivery. Because the treating physician has been interfaced in the decision, an online pharmacy that is filling the prescription has no concern about the physician's license based on where the patient is located. In addition, the patient benefits tremendously by not having to have a face-to-face visit with the physician to obtain a prescription. The PDO would oversee any service fees that are paid to the doctors and are the ones that are going to measure whether the doctor is really using the Internet disease management tools effectively and then administer those fees.

The physician payment strategy would include managed care concepts (see Slide 19). The kind of services physicians would actually be paid for is the oversight function, the clinical re-engineering function, actual patient services, giving care, clinical research, maintaining records in such a way as to deliver meaningful data back and receiving compensation in return. The payment model would also include safety concerns, creating incentive payments that relate to actual outcomes and patient satisfaction, among other factors.

The system also promotes the creation and maintenance of a secure health record that can be protected and audited against unauthorized use. Patients can control access and be advised when records are transmitted to others. The data and records maintained in the medical service bureau are encrypted to preclude disclosure of patient-specific information.

While certain segments of our society are not yet using the Internet, there are many venues emerging where participants in a secure Community Medical Extranet could interface. There is a sizeable roster of virtual customers for the present invention, along with clear market factors that the present invention would be in demand. This approach would be ideal for large self-funded employers such as Xerox® and its voucher system, or Ford® and Delta™, who have given all their employees computers. A pharmaceutical company may use the present invention in conjunction with its powerful sales force, using the Internet to obtain direct access to physicians. In addition, the PDO could agree to provide the formulary and, as part of the contract, there would be agreement not to counter-detail the company's products. See generally Slide 22. The bottom line is that the physician needs to make the best medically appropriate decision. By using the Internet PPO approach, the actual licensed physician in the community, the treating physician, makes the decision. Then there is no unlicensed practice of medicine issue because the treating physician helped to develop the formulary rather than the pharmaceutical company.

It is possible to set up the present invention at a large hospital system with thousands of physicians on their medical staff so that the hospital system had one source of revenue. If the hospital system so desires, it can itself be the one that pays the physicians for the source of revenue. The hospital system itself can pay the physicians for the services that they currently perform for so that they own that piece of it. This could be designed in a multiple of ways. For example, right now all the care is going out of hospitals, with hospitals refocusing on hospital services. There really is no mechanism for coordinating care, other than looking over the doctors' charts in their individual offices and their inpatient and outpatient facilities.

While the preferred embodiment of the present invention discloses that physicians are included in the health care provider network and methods described above, the health care provider network is not limited thereto, and other qualified health care professionals may be included in the health care provider networt. For example, but not by way of limitation, nurses, podiatrists, dentists, chiropractors, or other medical professionals at various levels may also be connected in similar hosted environments for various medical specializations.

The present invention has various advantages. For example, but not by way of limitation, accuracy and precision of treatment are improved due to standardization and decreased time between onset of the medical condition and commencement of treatment. Money is saved due to the decreased need for in-patient procedures, hospital beds, and the like, and the associated decrease in overhead. Further, improved participation and standardization of CRO's will lead to more accurate results, better participation, and more rapid use of safe, new medical treatments.

Additionally, the globalization of the present invention overcomes the prior art problems of time delay and increased cost in obtaining basic access, and simplifies the process of purchasing and accessing health care treatment in other countries having different languages, currencies, protocols or the like. Thus, access to health care is improved, and the overall health of participating patients is increased at a reduced cost to the patient, employer and the government.

It will be apparent to those skilled in the art that various modifications and variations can be made in methods and apparatus for managing a tour product purchase of the present invention without departing from the spirit or scope of the invention. Thus, it is intended that the present invention cover the modifications and variations of this invention provided they come within the scope of the appended claims and their equivalents. Further, the additional embodiments that would have been obvious to one skilled in the art are included in the present invention.

1. A method of delivering health care services in a networked environment, comprising the steps of:
receiving a health care treatment request having at least one parameter from a user to a hosted environment;
transmitting said health care request from said hosted environment to at least one health care provider, and at least one of said health care provider and said hosted environment generating with the networked environment health care diagnostic, treatment and/or management instructions in accordance with said at least one parameter;
providing at least one of said health care provider and said user with said health care diagnosis, treatment and/or management instructions; and
remotely treating a patient in accordance with a standardized level of care.

2. The method of claim 1, further comprising:
receiving at least one vital sign or symptom from said patient through said networked environment; and
adjusting said health care diagnostic, treatment and/or management instructions in accordance with said at least one vital sign or symptom.

3. The method of claim 2, wherein said receiving step comprises receiving at least one of body temperature, breathing rate, blood pressure, pulse rate, skin color, blood chemical composition, and a tissue health indicator through a medical device positioned with said patient and remotely from said health care provider.

4. The method of claim 1, further comprising generating a standardized, secure electronic medical history, audit trail and updating, integrating and/or monitoring records of said patient.

5. The method of claim 4, further comprising at least one of the steps of:
generating a personalized, secure user interface in said networked environment for said user;
creating a risk profile by one of maintaining electronic medical history and/or performing genetic tests to map the genes of said patient and reviewing said patient's genetic history via a family tree;
accessing said records on a world wide basis across countries in a standardized manner; and
one of collecting and collating standardized data so as to alter said records.

6. The method of claim 1, wherein said health care provider is created by aggregating records of a plurality of participating, licensed health care providers into a single network.

7. The method of claim 1, wherein said receiving, transmitting, providing and remotely treating steps are performed via one of wireless communication and a global positioning system (GPS).

8. The method of claim 1, further comprising at least one of scheduling a patient appointment, directing said patient to an optimal access point for health care services, filling a prescription order, and generating a reimbursement request in accordance with said health care treatment request.

9. The method of claim 1, further comprising:
providing warnings, alerts, contraindications and/or reminders to one of said user and said patient and receiving feedback information from one of said user and said patient; and
adjusting said health care diagnostic, treatment and/or management instructions in accordance with said feedback information.

10. The method of claim 1, further comprising applying a first medical device to said patient to obtain medically relevant data.

11. The method of claim 10, further comprising applying a second medical device to said patient to perform said remotely treating step.

12. The method of claim 1, wherein said health care instructions are generated in accordance with a past medical history of said patient.

13. The method of claim 1, further comprising preserving patient confidentiality by prompting said user as to whether to release medically relevant confidential information.

14. The method of claim 1, wherein said method can be standardized globally to operate independent of language, currency and health care access system.

15. The method of claim 1, further comprising remotely generating an automated response to other health care providers comprising information about said health care diagnosis, said treatment and/or said management services received by said patient.

16. The method of claim 1, further comprising directly linking said diagnostic, treatment and/or management services to said remotely treated patient with an assessment and/or recommendation from said health care provider.

17. The method of claim 1, further comprising consolidating, maintaining and updating a composite patient electronic medical history remotely accessible by said patient or a physician.

18. The method of claim 1, further comprising providing said patient with direct access to diagnostic, treatment or management services with the oversight of said at least one treating health care provider.

19. The method of claim 1, further comprising performing clinical research, including the steps of:
identifying physicians to participate in clinical studies;
enrolling a patient in a hosted, health care network;
generating a multigenerational family history in a profile of said patient in said health care network;
identifying whether said patient is a candidate for clinical research; and
conducting said clinical research with said patient in a networked, hosted environment.

20. The method of claim 19, further comprising:
determining results of said clinical research;
comparing said clinical research results to said patient profile to generate a comparison result; and
prompting said patient to apply said clinical research results to treatment instructions for said patient, wherein said clinical research result comprise a previously unavailable medical treatment.

21. The method of claim 19, further comprising documenting said clinical research in a globally accessible database having a standardized protocol.

22. A hosted system that provides a patient with health care diagnosis, treatment and/or management, comprising:
a sponsor network that determines at least one component of said hosted health care diagnosis, treatment and/or management and integrates said at least one component to generate at least one standardized health care diagnostic, treatment and/or management practice;
a treatment network that conducts credentialing of health care providers, audits and monitors said hosted system and health care providers, and performs said health care diagnosis, treatment and/or management in a networked environment; and
a client enrolled in said hosted system and interacting with said health care diagnostic, treatment and/or management network through an user interface to provide said health care treatment and administration remotely from said health care providers in accordance with said at least one integrated component having said at least one standardized health care diagnostic, treatment or management practice.

23. The system of claim 22, wherein said client transmits at least one vital sign or symptom of said patient through said sponsor network, and said sponsor network adjusts said health care diagnostic, treatment and/or management instructions in accordance with said at least one vital sign or symptom.

24. The system of claim 23, said at least one vital sign or symptom comprising at least one of body temperature, breathing rate, blood pressure, pulse rate, skin color, blood chemical composition, and a tissue health indicator, received through a medical device positioned at said patient and remotely from said health care provider.

25. The system of claim 22, wherein said sponsor network generates a standardized, secure electronic medical history, audit trail and updates, integrates and/or monitors records of said patient.

26. The system of claim 25, further comprising at least one of:
a personalized, secure user interface in said networked environment for said user;
a risk profile comprising one of an electronic medical history and/or a genetic test to map the genes of said patient and review said patient's genetic history, wherein said records are standardized on a world wide basis across countries.

27. The system of claim 22, wherein said health care provider comprises an aggregation of a plurality of participating, licensed health care providers into a single network.

28. The system of claim 22, wherein said sponsor network, said treatment network and said client communicate via at least one of wireless communication and a global positioning system (GPS).

29. The system of claim 22, wherein said sponsor network one of schedules a patient appointment, directs said patient to an optimal access point for health care services, fills a prescription order, and generates a reimbursement request in accordance with said health care treatment request.

30. The system of claim 22, further comprising:
warnings, alerts, contraindications and/or reminders transmitted from said sponsor network to said client; and
a feedback signal received from said client and used by said sponsor network to adjust and monitor said health care diagnostic, treatment and/or management instructions.

31. The system of claim 22, further comprising a first medical device used to obtain medically relevant data from said patient, said medical device comprising at least one of a viewing scope with a camera that can be controlled by said health care provider, a sphygmomanometer, a thermometer, a microphone that transmits audio signals to said sponsor network, a blood characteristic monitoring device, and a tissue sampling device.

32. The system of claim 31, further comprising a second medical device that remotely treats said patient, said second medical device comprising at least one of a medicine injection device, a robotic surgery device, and treatment administration device.

33. The system of claim 22, wherein said health care treatment is generated in accordance with a past medical history of said patient.

34. The system of claim 22, wherein said sponsor network preserves patient confidentiality by prompting said user as to release medically relevant confidential information.

35. The system of claim 22, wherein said system is standardized globally to operate independent of language, currency and health care access system.

36. The system of claim 22, wherein said sponsor network remotely generates an automated response to other health care providers comprising information about said health care diagnosis, said treatment and/or said management services received by said patient.

37. The system of claim 22, further comprising an assessment and/or recommendation from said health care provider, linked from said diagnostic, treatment and/or management services to said remotely treated patient.

38. The system of claim 22, further comprising a composite patient electronic medical history remotely accessible by said patient or a physician.

39. The system of claim 22, further comprising a direct access link to diagnostic, treatment or management services with the oversight of said at least one treating health care provider.

40. The system of claim 22, further comprising a virtual clinical research organization that includes a patient enrolled in a hosted, health care network, including:
a patient profile comprising a history and multigenerational family history in a said health care network;
an automated identifier that determines whether said patient is a candidate for clinical research; and
a clinical research enrollment and management system in a networked, hosted environment.

41. The system of claim 40, wherein
results of said clinical research are disseminated to networked treating providers for use with patients who qualify for new treatments developed based on said results of clinical research.

42. The system of claim 40, further comprising a globally accessible database having a standardized protocol that documents said clinical research.

43. A system that provides health care diagnosis, treatment and/or management to a patient, comprising:
a request, generated by an user, received by an application service provider (ASP), said user request comprising a plurality of parameters;
an output to a health care network from said ASP, said health care network including at least one health care provider, that generates a health care diagnostic, treatment and/or management instruction transmission to said ASP; and
a treatment instruction output from said ASP to said user, wherein said health care diagnosis, treatment and/or management is performed remotely from said health care provider in accordance with at least one of said health care diagnostic, treatment and/or management instruction and feedback from said user.

44. The system of claim 43, further comprising:
at least one vital sign or symptom output signal from said user to said health care network; and
a health care diagnostic, treatment and/or management adjustment signal generated in accordance with said at least one vital sign or symptom output signal.

45. The system of claim 44, wherein said at least one vital sign or symptom comprises at least one of body temperature, breathing rate, blood pressure, pulse rate, skin color, blood chemical composition, and a tissue health indicator generated by a medical device positioned with said patient and remotely from said at least one health care provider.

46. The system of claim 43, further comprising a standardized, secure electronic medical history, audit trail, wherein updating, integrating and/or monitoring records of said patient occurs in accordance with a user-generated signal.

47. The system of claim 46, further comprising at least one of:
a personalized, secure user interface in said networked environment for said user to communicate with said health care network;
a risk profile that one of maintains electronic medical history and/or performs genetic tests to map the genes of said patient, and reviews said patient's genetic history; and
a standardized, globally accessible electronic medical history, wherein said health care network is configured to one of collect and collate data so as to alter said electronic medical history.

48. The system of claim 43, wherein said health care provider comprises a plurality of participating, licensed health care providers, aggregated as a single network.

49. The system of claim 43, wherein said system operates on one of wireless communication and a global positioning system (GPS).

50. The system of claim 43, wherein said health care network at least one of schedules a patient appointment, directs said patient to an optimal access point for health care services, fills a prescription order, and generates a reimbursement request via a health care treatment request signal.

51. The system of claim 43, further comprising:
one of a warning, alert, contraindication and/or reminder transmission to said user and feedback signals from said user, wherein said health care diagnostic, treatment and/or management instructions are adjusted in accordance with said feedback signal.

52. The system of claim 43, further comprising a first medical device applied to said patient to generate a medically relevant output.

53. The system of claim 52, further comprising a second medical device applied to said patient to remotely treat said patient.

54. The system of claim 43, wherein said treatment instruction output is generated in accordance with a past medical history of said patient.

55. The system of claim 43, further comprising preserving patient confidentiality in accordance with a command signal received from said patient to determine whether to release medically relevant confidential information and maintaining an audit trail.

56. The system of claim 43, wherein said system is standardized globally to operate independent of language, currency and health care access system.

57. The system of claim 43, further comprising a remotely generated, automated response from said health care provider to other health care providers comprising information about said health care diagnosis, said treatment and/or said management services received by said patient.

58. The system of claim 43, further comprising directly linking said diagnostic, treatment and/or management services to said remote patient via an assessment and/or recommendation from said health care provider.

59. The system of claim 43, further comprising a composite patient electronic medical history that is remotely accessible by said user or a physician.

60. The system of claim 43, wherein direct access is provided to diagnostic, treatment or management services to said user with the oversight of said at least one treating health care provider.

61. A method of performing clinical research, comprising:
enrolling a patient in a hosted, health care network;
generating a multigenerational family history in a profile of said patient in said health care network;
identifying whether said patient is a candidate for clinical research; and
conducting said clinical research with said patient in a networked, hosted environment.

62. The method of claim 61, further comprising:
determining results of said clinical research;
comparing said clinical research results to said patient profile to generate a comparison result; and
prompting said patient to apply said clinical research results to treatment instructions for said patient, wherein said clinical research result comprise a previously unavailable medical treatment.

63. The method of claim 61, further comprising documenting said clinical research in a globally accessible database having a standardized protocol.

64. The method of claim 61, further comprising:
enrolling a physician in said hosted, health care network;
assessing qualifications of said physician and assessing a patient database of said physician;
determining a qualification status of said physician in accordance with results of said assessing step, wherein said physician is retained to conduct a trial if said physician qualifies in said determining step; and
interfacing with said patient database if said physician qualifies in said determining step and conducting said trial.

65. The method of claim 64, further comprising:
Determining whether said trial produced a new medical treatment;
Identifying physicians having patients with characteristics indicative of qualification for said new medical treatment; and
Prompting said physician to offer said new medical treatment to said patient, wherein said identifying and prompting steps are conducting if said determining step indicates production of said new medical treatment.
